(19) United States
(12) Patent Application Publication
(10) Pub. No.: US 2010/0148569 A1
(43) Pub. Date: Jun. 17, 2010

(54) Wheel cover arresting device

(76) Inventor: Chen-Chun Chen, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/453,701

(22) Filed: May 20, 2009

(30) Foreign Application Priority Data
Dec. 16, 2008 (TW) 097222561

(51) Int. Cl. B60B 7/08

(52) U.S. Cl. 301/37.34

(57) ABSTRACT

This invention relates to an wheel cover arresting device in which a plurality of retaining sockets are integrally formed at the rear side of the wheel cover body. Each retaining socket is pivotedly connected with a catch member at one end, and the other end of the catch member abuts against a groove provided on the wheel cover body. Furthermore, a wave-shape elastic portion with definite elastic force is formed on each catch member. Two ends of each catch member abut against the wheel disk body and the wheel cover body respectively after the completion of assembly process. An appropriate force has to be applied so as to detach the wheel cover body from the front side of the wheel disk body. This can also ensure that the wheel cover body will not easily be stripped from the wheel disk body. It is the elastic portion of the catch members that provide the appropriate definite elastic force to allow the catch members to firmly abut between the wheel disk body and the wheel cover body and to enhance the stability of this abutment.

### BACKGROUND OF THE INVENTION

1. Field of the Invention

This invention relates to a wheel cover arresting device, particularly to a wheel cover arresting device which can arrest the wheel cover body onto the front side of the wheel disk body and enhance the stability by means of catch members.

2. Brief Description of the Prior Art

Wheel disks provided on the lower part of car is not a main part of car body, but is closely linked with car performance and car manipulation. Not only there is impartible relationship between the size of wheel disk and the aspect ratio of wheel, but also the weight of wheel itself affects the acceleration performance of car. What is more, wheel disk plays a decisive role in total appearance and design of a car. Accompanying with the progress of material science, wheel disk has been evolved from an iron disk at early stage to one made by high level material such as aluminum alloy or aluminum magnesium wheel disk nowadays, and manufacturing method is change from casting at former stage to forging today. Furthermore, multi-element wheel disk represents the symbol of high performance. Therefore, the car emphasizing high-speed is often seen that its wheel disks are exposed to the outside of the wheel arch to enable the widening of the wheel track. In this manner, the widened wheel track can avoid the weight center of the car from changing over when making a turn running on curved road so as to enable the raising of turning speed limit for car.

The above wheel disk is arrested with a wheel cover. Referring to FIG. 14 of a Taiwanese Patent Gazette No. 475,521 entitled “Wheel Cover Arresting Structure”, the wheel cover arresting structure comprises: a plurality of retaining sockets (5) each having a hole (51) provided on the annular edge of the wheel cover; a plurality of catch members (6) separately provided, each of which has a base (61), two side wings (62) being respectively formed on both sides of the base (61), one end of each side wing (62) having a retaining portion (63) and the other end having a hook (64), a plate (65) being formed on the base (61) in such a manner that the gap formed between the plate (65) and the retaining portion (63) can clip the peripheral edge of wheel rim. With the above structure, when the hooks (64) of the side wings (62) of the catch member (6) are inserted into the holes (51), two hooks (64) slightly contracted inwardly according to its elasticity until the hooks (64) pass through the holes (51) on the retaining socket (5). Then the two hooks (64) expand outwardly and are blocked at the rear end of the retaining socket (5). Thus, the catch member (6) is arrested.

However, the above wheel cover arresting structure suffers the following defects in practical application:
1. In the above wheel cover arresting structure, the hooks of the catch member are inserted into the holes of each retaining socket and are blocked at the rear end of the retaining socket by the elasticity itself. However, the elasticity of the hooks is quite restricted so that the arresting might be unstable.
2. The above wheel cover arresting structure is to arrest the wheel cover by inserting the catch member into the retaining socket. However, the irregular structure of the catch member will occupy substantial large space for the integral assembled and packed volume of the same. Therefore, business competitiveness will become vulnerable due to the increasing transportation cost.
3. In view of bigger volume after packing, wheel covers stacking together take bigger storage space. Thus, cost-up will be caused by bigger storage space, additional handling and transportation in factory.

### SUMMARY OF THE INVENTION

In view of the above defects, this invention provides a wheel cover arresting device having a plurality of catch members used to arrest the wheel cover body onto the front side of the wheel disk body, so that the wheel cover will not be stripped from the wheel disk can be ensured. Besides, stacking of wheel covers is not negatively affected by the height of the catch member so that space saving is possible. The elastic force owned by the catch members is to ensure good abutment between the wheel cover body and the wheel disk body so as to enhance the stability during abutment.

A preferred embodiment of the wheel cover arresting device according to the present invention is characterized in that the wheel cover arresting device has an wheel cover body and an wheel disk body, a plurality of retaining sockets being integrally formed at the rear side of the wheel cover body, each retaining socket being pivotedly connected with a catch member at one end and the other end of the catch member being abutted against a groove provided on the wheel cover body, a wave-shape elastic portion having opposite peaks being formed on each catch member to provide each catch member with definite elastic force.

According to the first embodiment of the wheel cover arresting device of the present invention, the pivot-coupling portion of each retaining socket is the extending edges, and the pivot joints of each catch member has blocking portion which is caught with the extending edges of the retaining socket.

According to the first embodiment of the wheel cover arresting device of the present invention, the pivot coupling portion of each retaining socket is a cylindrical rod and the pivot joints of each catch member is of claw shape which pivotedly mounted on the cylindrical rod.

### BRIEF DESCRIPTION OF THE DRAWINGS

FIG. 1 is a schematic view showing the stacking state of wheel cover bodies of the present invention.

FIG. 2 is a perspective exploded view showing the retaining socket and the catch member of the first embodiment of the present invention.

FIG. 3 is a sectional view showing the assembly of the retaining socket and the catch member of the first embodiment of the present invention.

FIG. 4 is a view showing the rotation state of the catch member of the first embodiment of the present invention.

FIG. 5 is a view showing the state of the catch member of the first embodiment of the present invention, before the catch member is abutted against the groove.

FIG. 6 is a view showing the state of the catch member of the first embodiment of the present invention, when the catch member is abutted against the groove.

FIG. 7 is a view showing the state of the catch member of the first embodiment of the present invention, after the catch member is abutted against the groove.

FIG. 8 is a sectional view showing the assembly of the retaining socket and the catch member of the second embodiment of the present invention.

FIG. 9 is a perspective exploded view showing the retaining socket and the catch member of the third embodiment of the present invention.

FIG. 10 is a perspective exploded view showing the retaining socket and the catch member of the fourth embodiment of the present invention.

FIG. 11 is a perspective exploded view showing the retaining socket and the catch member of the fifth embodiment of the present invention.

FIG. 12 is a perspective exploded view showing the retaining socket and the catch member of the sixth embodiment of the present invention.

FIG. 13 is a sectional view showing the assembly of the retaining socket and the catch member of the sixth embodiment of the present invention.

FIG. 14 is a perspective exploded view of a prior art.

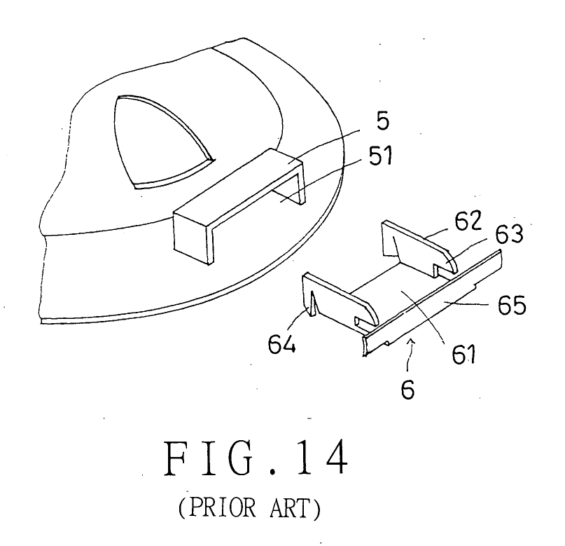

### DETAILED DESCRIPTION OF THE PREFERRED EMBODIMENTS

The objects, the technical contents and the expected effectiveness of the present invention will become more apparent from the detailed description of the preferred embodiment in conjunction with the accompanying drawings.

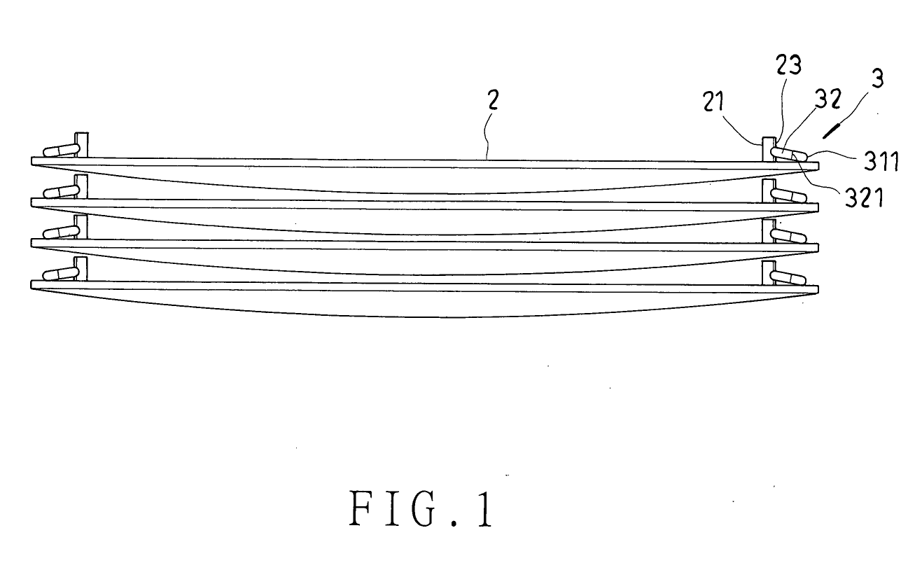

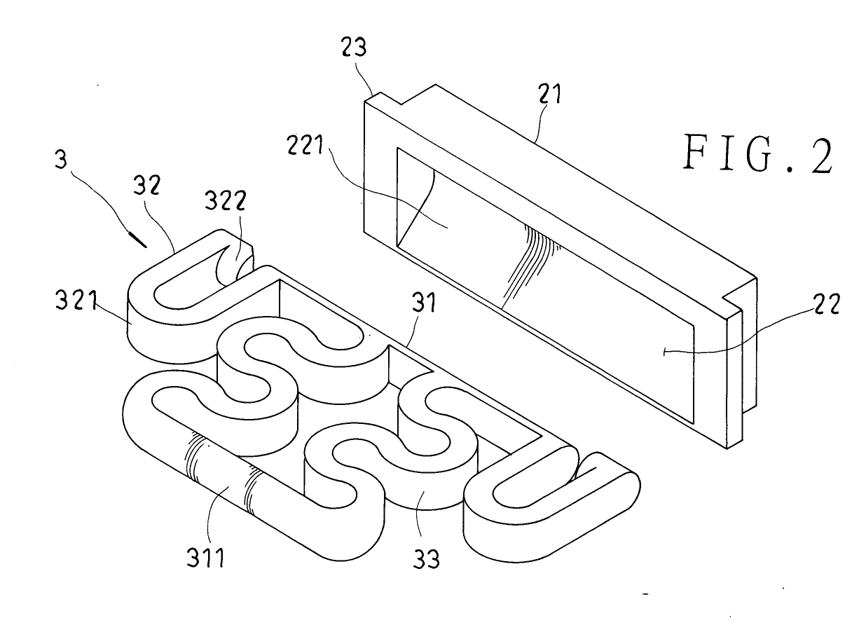

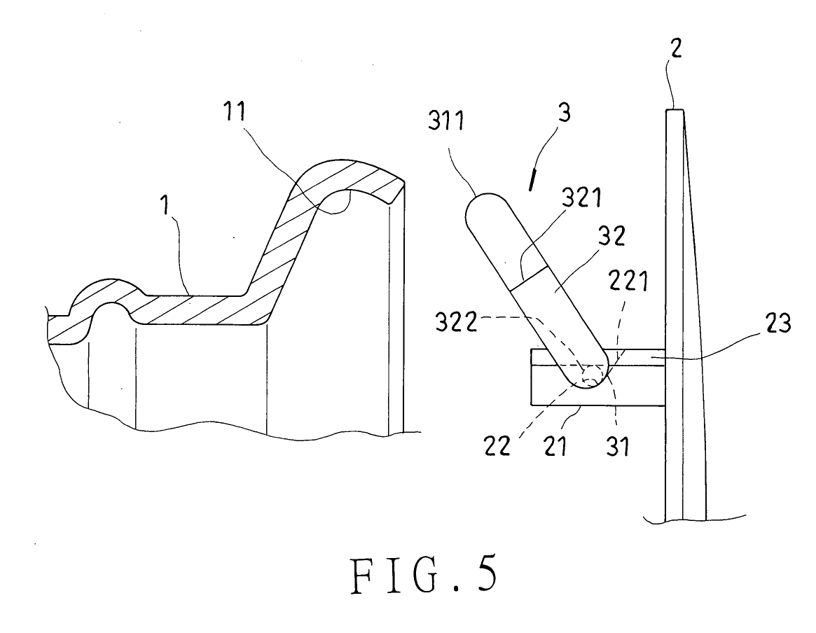

Firstly referring to FIGS. 1 and 2 showing the first preferred embodiment of the wheel cover arresting device according to the present invention, it comprises a wheel disk body (1) as shown in FIG. 5, an wheel cover body (2) and a plurality of catch members (3).

The wheel disk body (1) is made of metal material by means of casting or forging, grooves (11) are formed respectively at the outer edges of the front and the rear sides of the wheel disk body (1) by bending the outer edges inward so that the catch members (3) can abut against the grooves (11). Then, the wheel cover body (2) can be arrested onto the front side of the wheel disk body (1).

The wheel cover body (2) is a disk having a convex surface, which is formed integrally with a plurality of retaining sockets (21) at the peripheral edge of its rear side. Each retaining socket (21) is a rectangular box type body which has a height approximately equal to the distance from the center point of the wheel cover body (2) to the peripheral edge. In this manner, the stacking height of wheel cover bodies (2) can be reduced so as to save storage space in factory. A cavity (22) with rectangular opening is formed in the interior of each retaining socket (21), which has a ramp (221) slanted from the top end face to the bottom end face. In addition, edge portions acted as pivot coupling portions (23) are provided at both sides respectively of each retaining socket for seizing with the pivot joints (32) of each catch member (3).

The cross sectional area of each catch member (3) is smaller than that of each cavity (22) of the wheel cover body (2) so that each catch member (3) placed inside the cavity (22) has enough space to rotate. Both circularly shaped inner side edge (31) and outer side edge (311) are formed at the front and rear ends respectively of each catch member (3). The inner side edge (31) is formed, respectively at both ends, with pivot joints (32) which are arch shape stripe bodies parallel to both sides of each catch member (3) and are connected with bent portions (321). A blocking portion (322) opposite to the inner side edge (31) is provided on the terminal of each pivot joint (32), which is catching with the pivot coupling portion (23) of the wheel cover body (2). Moreover, an elastic portion (33) of wave-shape with its peaks opposite to each other is formed between the inner side edge (31) and the outer side edge (311) of each catch member (3). By means of the elastic portion (33), each catch member (3) is applied with definite elastic force which allows the catch member (3) to conduct firm abutment between the wheel disk body (1) and the wheel cover body (2), and to enhance the stability of the abutment.

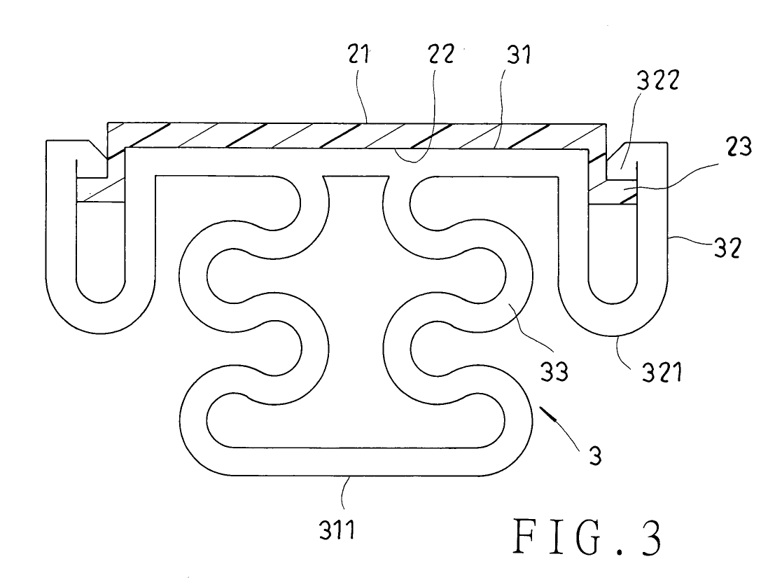

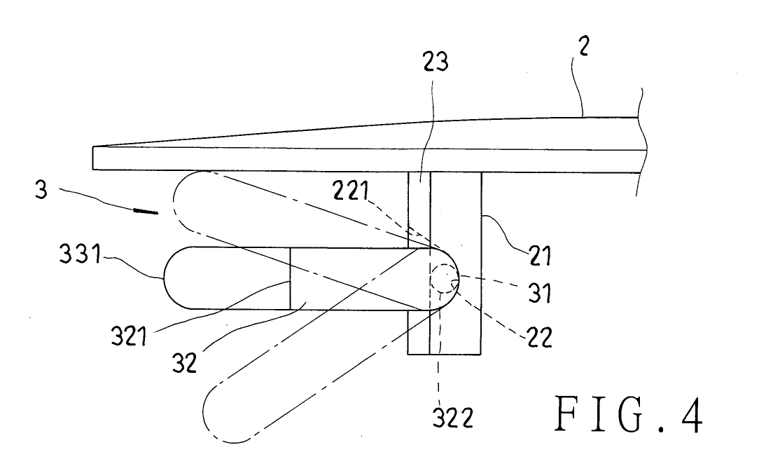

Referring to FIGS. 1 to 4, when performing the assembly, the inner side edge (31) of each catch member (3) is inserted into the cavity (22) of each retaining socket (21) formed on the peripheral edge of the wheel cover body (2) and is abutted against the inner side wall of the cavity (22), and the blocking portion (322) at the inner side of each pivot joint (32) is caught with corresponding pivot coupling portion (23). Inasmuch as the cross sectional area of each catch members (3) is smaller than that of each cavity (22) of the wheel cover body (2), so that each catch member (3) can be rotated in the cavity (22) with the inner side edge (31) as the center. Then, the inner and outer side faces of each catch member (3) close or even lean against the ramp (221) within the cavity (22), i.e., each catch member (3) is rotated to allow the outer side edge (311) lean against the wheel cover body (2). Therefore, the wheel cover bodies (2) assembled in the same manner can be stacked together to form laminar structure. Because the height of each retaining socket (21) is approximately equal to the distance from the center point of the wheel cover body (2) to the peripheral edge, the stacking height of the wheel cover bodies (2) can be reduced so as to save storage space in factory. Therefore, the transportation cost either in export delivery or multi-stage inland delivery can be reduced remarkably.

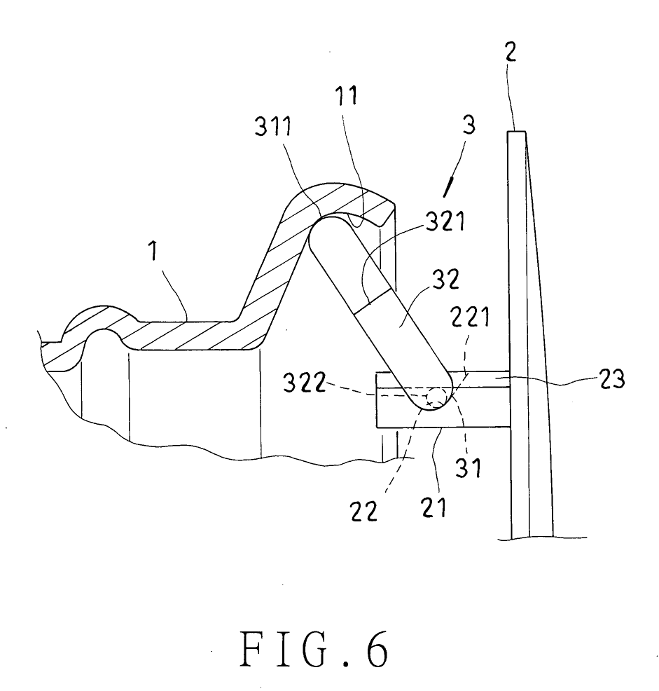

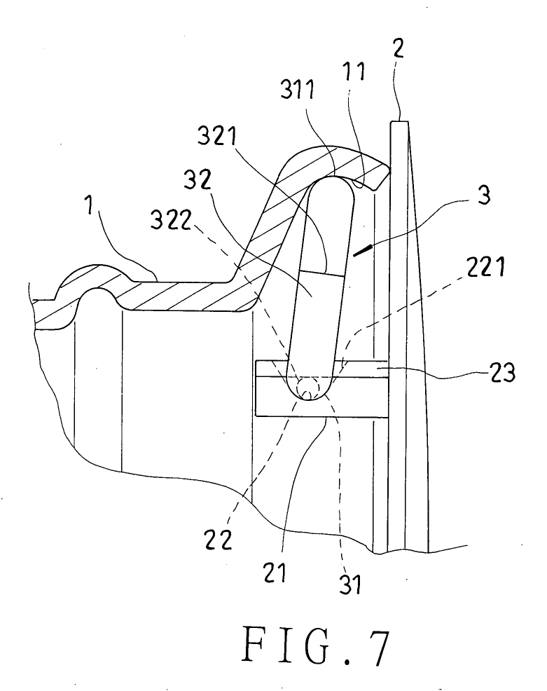

In the implementation of combining the wheel cover body to the wheel disk body, as shown in FIGS. 5 to 7, each catch member (3) is firstly rotated in the cavity (22) of the retaining socket of the wheel cover body (2) with the inner side edge (31) as the rotation axis, and the outer side face of each catch member (3) leans against the ramp (221) at the outside of the cavity (22) so that the outer side edge (311) is slanted to the rear side of the wheel cover body (2). Then, the wheel cover body (2) with the catch members (3) is moved to the front side of the wheel disk body (1) and the outer side edge (311) of each catch members (3) is abutted firmly against the groove (11) of the wheel disk body (1). Next, the wheel cover body (2) is pressed so as to be arrested on the front side of the wheel disk body (1). Thus, each catch member (3) is moved by the retaining socket (21) to rotate so that the outer side edge (311) of each catch member (3) is slanted to the wheel cover body (2) and is abutted firmly against the outer side of the groove (11). Each catch member (3) is formed with a wave-shape elastic portion (33) having definite elastic force by which each catch member (3) can be compressed a certain amount for easy rotation of the catch members (3). Also, an appropriate abutting force can be provided by the elastic force generated by the elastic portion (33) after the completion of assembling. On the other hand, if the wheel cover body (2) is to be detached from the front side of the wheel disk body (1), each catch member (3) is moved by the retaining socket (21) to rotate with the outer side edge (311) of each catch member (3) as the rotation axis. However, since the inner side edge (31) and the outer side edge (311) at both ends of each catch member (3) are abutted firmly against the groove (11) of the wheel disk body (1) and the cavity (22) of the wheel cover body (2) respectively, it is not impossible to obtain enough space for each catch member (3) to rotate. Therefore, appropriate force is required to pull the wheel cover body (2) apart so that the outer side edge (311) of each catch member (3) is forced to move toward the inner side of the groove (11) so as to obtain enough space required for each catch member (3) to rotate. Then, the wheel cover body (2) can be detached from the front side of the wheel disk body (1). With this structure, the wheel cover body (2) can be stably installed on the front side of the wheel disk body (1) by means of catch members (3). In this manner, the wheel cover body (2) can resist the wind drag happened during the driving of car so as not to be stripped from the wheel disk body (1).

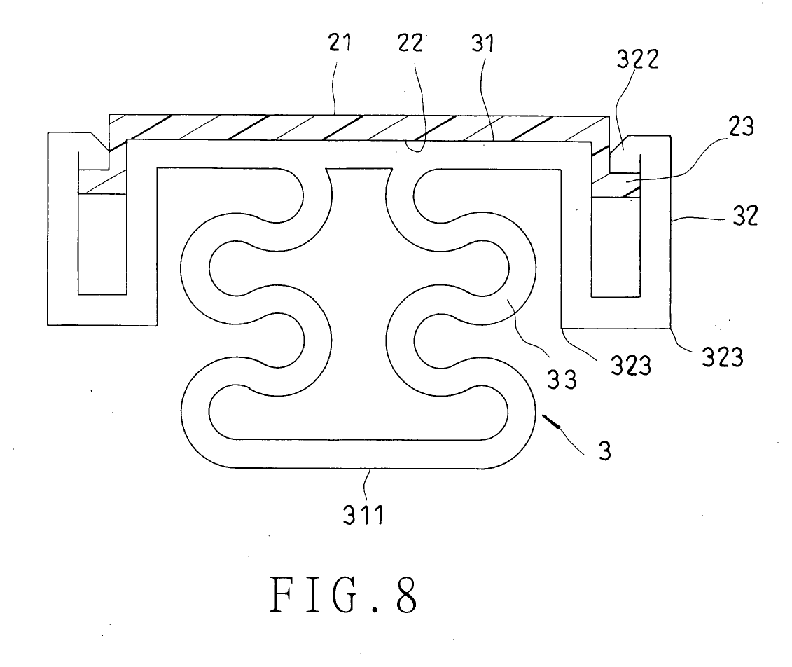

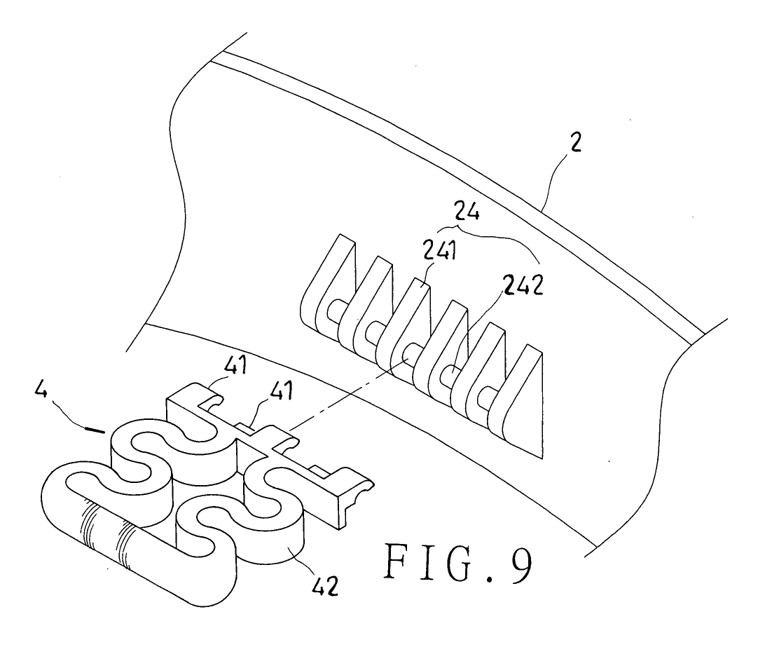

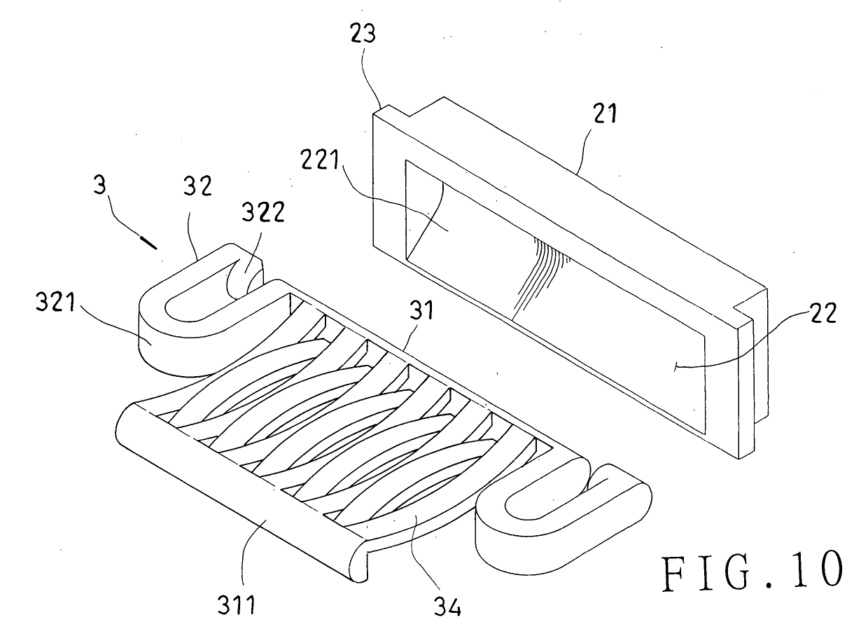

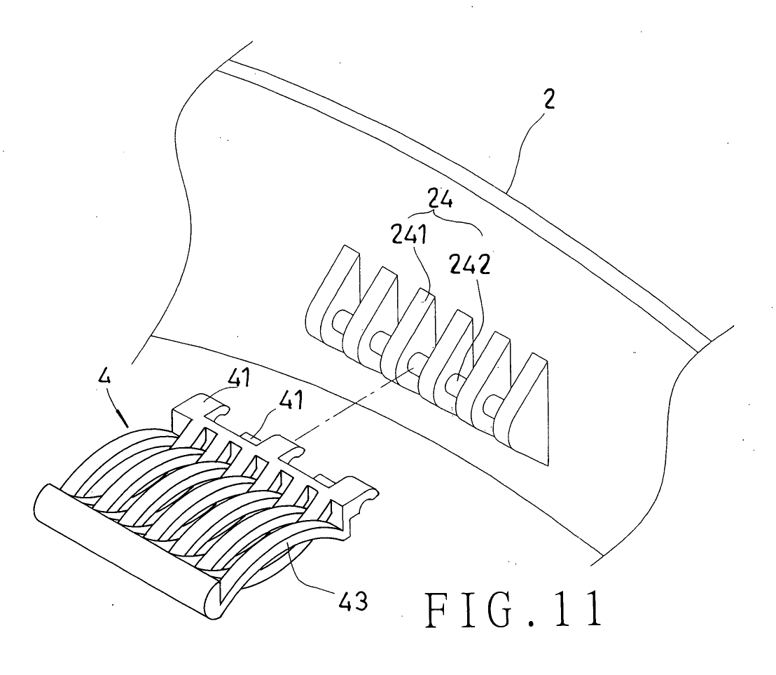

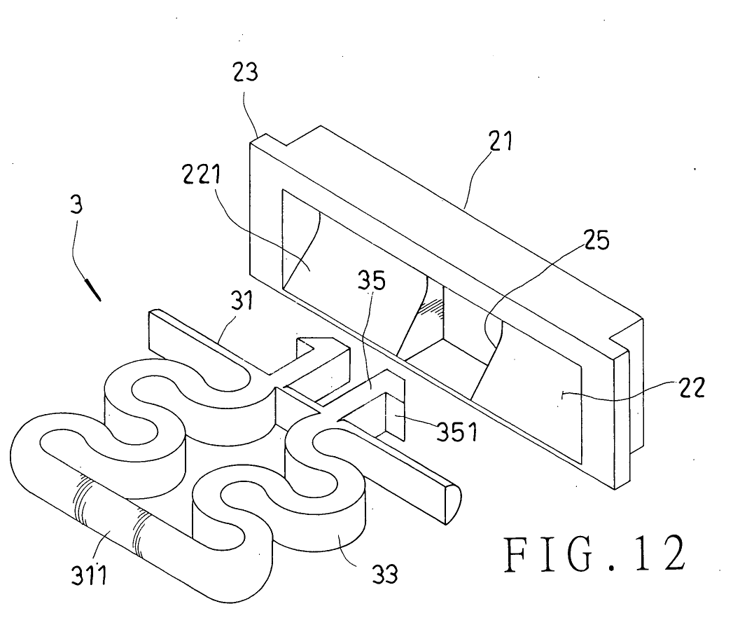

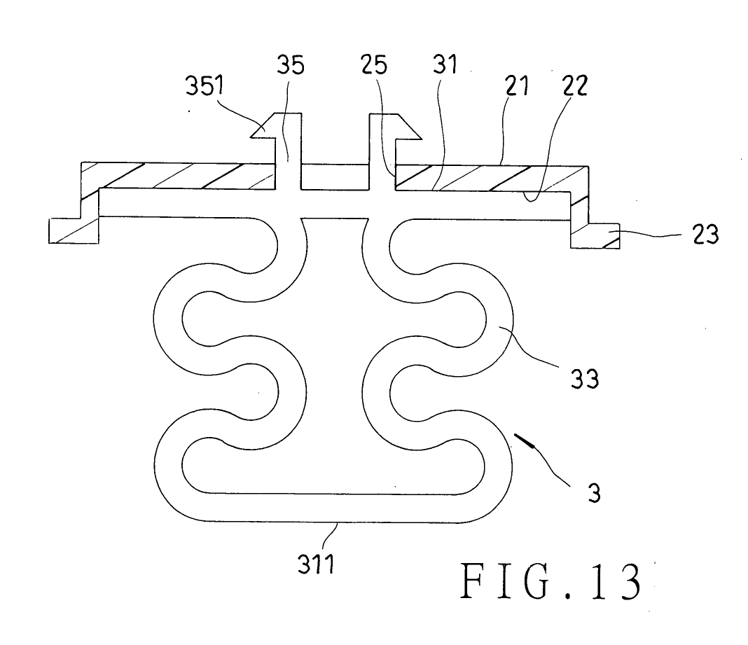

FIG. 8 is a schematic view showing the second preferred embodiment of the wheel cover arresting structure of the present invention. The difference of this embodiment with the first preferred embodiment is that the pivot joints (32) of each catch member (4) are formed with a continuous bending portion (323) of right angle shape. FIG. 9 is a schematic view showing the third embodiment of the present invention. Each retaining socket (24) is provided with a plurality of support elements (241) at the front side, a cylindrical rod acted as the pivot coupling portion (242) is penetrated through the support elements (241). A plurality of pivot joints (41) of claw shape are provided oppositely and alternately on the upper and lower sides of the rear end of each catch member (4), and the pivot joints (41) of each catch member (4) are pivotedly mounted on the pivot coupling portion (242) of the retaining socket (24). Thus, each catch member (4) is rotated with the pivot coupling portion (242) of the retaining socket (24) as the rotation axis such that operator can conduct the arresting operation. Each catch member (4) is also formed with a wave-shape elastic portion (42) having definite elastic force. FIG. 10 is a schematic view showing the fourth embodiment of the present invention, while FIG. 11 the fifth embodiment of the present invention. Comparing to the other preferred embodiments, the difference is that the elastic portions (34), (43) of each catch member (3), (4) of the fourth and fifth embodiments are of circular arc shape and are arranged alternately, i.e., the elastic portions (34), (43) are in parallel connection state. Thus, higher equivalent elastic coefficient can be obtained so as to get excellent elastic force and abutting force which can resist higher external force. FIGS. 12 and 13 are schematic views showing the sixth embodiment of the present invention. As shown in these figures, each pivot coupling portion (25) of the wheel cover body (2) is an opening located at the center of the inner side of the cavity (22), and the pivot joint (35) of each catch member (3) is a number of strip elements provided at the center of the inner side edge (31), which are opposite to the pivot coupling portion (25). A hook (351) is provided at the end of each pivot joint (35) for locking with the pivot coupling portion (25) of the wheel cover body (2). However, the abovementioned embodiments and drawings are not restrictive to the scope of the present invention. Appropriate variations and modifications made by the person having general knowledge in the art, such as aspect of product, pivot joint structure or quantity of the retaining socket and catch member, without departing from the spirit and scope of the present invention are still considered to be further embodiments of the present invention.

Based on the foregoing, the wheel cover arresting structure has the advantages set forth below when compared with prior art.

1. After completion of assembling, each catch member rotates in such a manner that two ends of each catch member respectively abut firmly against the wheel disk body and the wheel cover body. Thus, the wheel cover body can be arrested stably on the front side of the wheel disk body. Therefore, wheel cover body can resist the wind drag happened during the driving of car so as not to be stripped from the wheel disk body.

2. Each catch member is formed with an wave-shape elastic portion which can provide the catch member with definite elastic force to conduct firm abutment between the wheel disk body and the wheel cover body, and to enhance the stability of the abutment.

3. The stacking of wheel covers of the present invention is not negatively affected by the height of each catch member. So, the stacking height of wheel covers can be reduced so as to save storage space in factory. Therefore, the transportation cost either in export delivery or multi-stage inland deliveries can be reduced remarkably.

Summing up above, the wheel cover arresting structure according to this invention can reach expected effectiveness, and the specific configurations disclosed herein have yet not seen in the prior art of the same category of product, even has not been opened to the public before application.

What is claimed is:

1. A wheel cover arresting structure, comprising an wheel cover body, an wheel disk body, and a plurality of catch members, said wheel cover body having a plurality of retaining sockets each of which is formed with a pivot coupling portion, each catch member being formed with pivot joints at one end which are pivotedly mounted on said pivot coupling portion, and the other end of said catch member being firmly abutted against a groove formed on the wheel disk body, wherein each catch member is formed with an elastic portion.

2. A wheel cover arresting structure as claimed in claim 1, wherein each retaining socket is formed with a cavity for being inserted by said catch member.

3. A wheel cover arresting structure as claimed in claim 2, wherein the inner wall of the cavity is contracted from the top end face toward the bottom end face to form a ramp.

4. A wheel cover arresting structure as claimed in claim 1, wherein said pivot joint of each catch member is formed with a bending portion of circular arc shape.

5. A wheel cover arresting structure as claimed in claim 1, wherein said pivot joint of each catch member is formed with a bending portion of right angle shape.

6. A wheel cover arresting structure as claimed in claim 1, wherein the pivot coupling portion of said retaining socket is extending edges, and the pivot joint of each said catch member has a blocking portion to be caught with the pivot joint of the retaining socket.

7. A wheel cover arresting structure as claimed in claim 1, wherein the pivot coupling portion of each said retaining socket is a cylindrical rod and the pivot joints of the catch member is of claw shape, said pivot joints being pivotedly mounted on said pivot coupling portion.

8. A wheel cover arresting structure as claimed in claim 7, wherein said retaining socket has a plurality of support elements penetrated by the pivot coupling portion of the retaining socket.

9. A wheel cover arresting structure as claimed in claim 1, wherein said elastic portions of each catch member are of circular arc shape and are arranged alternately.

10. A wheel cover arresting structure as claimed in claim 1, wherein said pivot coupling portion of the wheel cover body is an opening provided at the inner side of the cavity, and said pivot joints of the catch member is opposite strip elements, a hook is provided at each pivot joint for locking with the pivot coupling portion.
